(19) United States
(12) Patent Application Publication
(10) Pub. No.: US 2009/0205904 A1
(43) Pub. Date: Aug. 20, 2009

(54) SYSTEM AS ATTACHMENT POSSIBILITY FOR SAFETY EQUIPMENT TO ARREST FALLS

(75) Inventors: Roland Appl, Nürtingen (DE); Ralf Walker, Dettingen (DE)

Correspondence Address: BROWDY AND NEIMARK, P.L.L.C.;624 NINTH STREET, NW, SUITE 300, WASHINGTON, DC, 20001-5303, US

(73) Assignee: ZinCo GmbH, Unterensingen (DE)

(21) Appl. No.: 11/719,145

(22) PCT Filed: Nov. 8, 2005
(86) PCT No.: PCT/EP05/11922

§ 371 Date: Mar. 2, 2009

(30) Foreign Application Priority Data
Nov. 11, 2004 (DE) 20 2004 017 539.8

(51) Int. Cl. A62B 35/00

(52) U.S. Cl. 182/3

(57) ABSTRACT

A System as attachment possibility for safety equipments to arrest falls produced by attachment points or, respectively, guide lines or rails secured by a weighting load, is designed so that a disk with a large area of adaptable size and form is composed of individual elements with a small area which are designed to be connected together. Said disk is arranged to be covered with a weighting load (as for example a bulk material, plates or the like) and is accordingly able to take up forces as occur in the case of arresting a fall by way of attachment points applied to it or integrated in individual elements.

### BACKGROUND OF THE INVENTION

The invention relates generally to roof safety systems.

Attachment possibilities for arresting falls during work at the edge of elevated surfaces (as for example servicing operations on flat roofs) of conventional design may be described as follows.

### THE PRIOR ART

1.) Fixed attachment points which may be designed as anchors set in masonry or concrete or as supports of steel tube, which are anchored in the underlying roof support structure and are so high that they project proud of the overlying roof layers. The disadvantages of this manner of construction in the case of in-sealed steel tube reside in the creation of heat or cold bridges when there is no cover in the form of a thermally insulating hood. Owing to the necessary penetration through the roof as a sealing structure additional connections are produced with the risk of leaks. The use of such fixed roof anchors is only possible at statically suitable positions.

2a.) Transportable attachment means held in place by their own weight or by weighting loads may as an example be constituted by water-filled pouches with a suitable size or rigid metal constructions loaded by weights.

Such manners of construction involves attachment means held by their own weight intended for temporary use and therefore made with such dimensions that they may be readily shipped. The results are relatively small engagement areas and this accordingly leads to heavy punctuate engagement requiring a substrate with sufficient load bearing capacity. Accordingly such roof anchor means are not suitable for light-weight roof designs as a rule. The time taken for anchoring is relatively long as compared with permanently installed roof anchor means.

2b.) Attachment means secured by superposed weighting loads for permanent installation on flat roofs use suitable bulk materials including for example also loaded nets or stout fabric as substrates with a suitable area it is possible to produce fixed roof anchors with eyes or loops, which are placed proud of the surface. Systems on these lines are free of any penetration of the roof. Accordingly the problems mentioned in part 1 above in connection with heat and cold bridges and furthermore risks of leaks are dealt with. Installation on an existing structure is possible as well if the load necessary can be in the form of suitable bulk materials.

Such attachment points provide the necessary arresting effect in the case of a fall owing to the weighting load behind them. The weighting load in front of the roof anchor is not or is only slightly effective as a retaining means. In the case of traction on the roof anchor there is a triangle of forces, i. e. the principal force is taken up diagonally rearwardly by the net or the fabric.

The net or fabric is prefabricated with the desired shape and will generally have a rectangular, such as a square, form or also a hexagonal or octagonal form. Customization to suit a specific roof geometry is not possible. In the case of a tension load there is a deformation of the rectangular, e. g. square netting or fabric, which is installed.

More particularly in the case of narrow roofs the use of netting or fabric is frequently impossible and recourse must be had to the various designs described in part 1 above. The interlock between netting and the substrate is only weak. A connection between individual attachment points with a sufficient bias load for safety systems using bracing cables with the possibility of moving over the individual fixed and corner points is not possible, seeing that the weighting load on the netting or, respectively, fabric is insufficient or there is no stiffening effect. The attachment points are as a rule arranged adjacent to the edge. This is necessary in the case of netting or fabric, which is not stiffened, to have as much weighting load on it as an effective fall arresting effect at the back of persons working on the roof. Tension loading is therefore not possible in all directions around the attachment point. This may lead to errors in use and accordingly to serious dangers. If work is so carried out that the safety line is parallel to the edge of the netting or the fabric the danger of the netting or fabric being torn out will be quite significant in a fall being arrested. Great care is therefore necessary to keep to the position of working. Operations at a corner with the adjacent areas using such system will therefore entail three re-anchorings.

3.) Safety systems with bracing lines or rails require either fixed attachment points (see part 1 above) that are connected with lines or rails or are secured at attachment points held apart by rods and weighted by a non-woven fabric cover. The disadvantage of the first design has already been indicated in part 1. In the case of second design mentioned there is the problem of only a limited adaptation to structures extending through the roof.

### SHORT SUMMARY OF THE INVENTION

One object of the invention is to provide a system of corrosion and rot resistant material (as for example of plastic or metal) which is composed of stiffened separate elements rigidly connected together more or less rigidly and which is covered with a suitable material (such as bulk material f. i. as a substrate, gravel, coarse sand or plates or the like) to such a level that on raised surfaces in conjunction with attachment points, which are more particularly frictionally applied to the individual elements or are integrated in the individual elements, can be utilized for personal safety equipment to arrest falls. This may be both as an individual attachment point solution and also by connection of individual fixed points in the form of bracing lines or rails.

Owing to the interconnected elements there is a patterned disk, with which the medium utilized as a weighting load is better employed in comparison with designs with netting or fabric. Owing to the design of a disk the complete weighting load provided on the disk takes effect as a support. Furthermore the bulk material etc. applied in front of the attachment point takes effect as a support. In the case of netting or fabric, which is not stiffened this can only be a part. All in all area of the system per attachment point may be less with the system in accordance with the invention. Unlike bidimensional netting or, respectively, fabric sheets the static friction and stiction may be improved by using three-dimensionally designed individual elements (ribs, upright ledges and walls).

Further advantageous developments and convenient forms of the invention will be understood from the following detailed descriptive disclosure of embodiments thereof in conjunction with the accompanying drawings.

### LIST OF THE SEVERAL VIEWS OF THE FIGURES

FIG. 1 shows a first working example of the system in accordance with the invention as represented diagrammatically on a narrow roof.

FIG. 2 represents a system in accordance with the state of the art as described in part 2b.) above.

FIG. 3 shows a second working embodiment of the system in accordance with the invention in a diagrammatic elevation, several disks in this case being illustrated on a roof which is wider than the roof of FIG. 1.

FIG. 4 shows a third working embodiment of the system in accordance with the invention in which disks are indicated for a surrounding safety system on the edge of the roof.

FIG. 5 shows a first and a second working example of an individual element for composing the disk in perspective.

FIG. 6 is a perspective view of a possible means for connection of individual elements with each other.

FIG. 7 is as plan view of the structure illustrated in FIG. 6.

FIG. 8 is a perspective view of separate components for the connection of a attachment point with a disk.

FIG. 9 is plan view of the structure depicted in FIG. 8.

### DETAILED ACCOUNT OF WORKING EMBODIMENTS OF THE INVENTION

List of parts of the arrangement.

1 Roof edge.

2 Disk within the meaning of the present invention.

3 Attachment point or fixed point connected permanently with the flat disk, netting or fabric sheet.

4 Working area.

5 Netting or fabric.

6 Line or a rail as a surrounding safety facility.

7 Light dome.

8 Structure extending through the roof such as a chimney or a vertical ventilation duct.

9 Individual elements for composing the disk with a floor (shown without connecting parts for the sake of simplicity in this case).

10 Individual element for the construction of the disk without a floor and grid-like ribs serving for stiffening (for the sake of simplicity illustrated without connecting parts).

11 Joint for the connection of the individual element in detail.

12 Detent action male member (not detachable or only detachable on overcoming a resistance).

13 A recess to receive the male part 12.

14 Example of the design of connection between individual elements in plan view.

15 Plate for connection with the plate 16.

16 Plate for connection with the plate 15 for example by means of cheese-head screws and nuts 17.

17 Connecting part, for instance a cheese-head screw with a nut illustrated in a substantially simplified manner.

18 Possible design of an attachment means for a line 19.

19 Line, for example of stainless steel, connected with the means 18 with a attachment eye for connection with safety equipment to arrest falls.

20 Guard and guide for the line 19, for example in the form of a vertical duct with a cover (not illustrated).

21 Hole for connection of the plate 15 with the plate 16 using suitable connecting material.

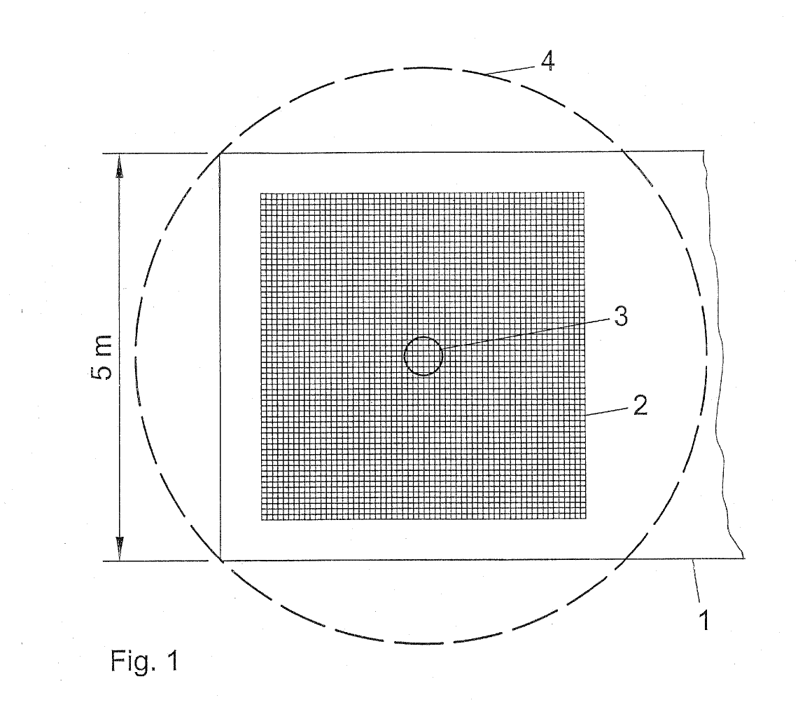

In the following there will be a description of the working examples of FIGS. 1 through 9 of the system in accordance with the invention.

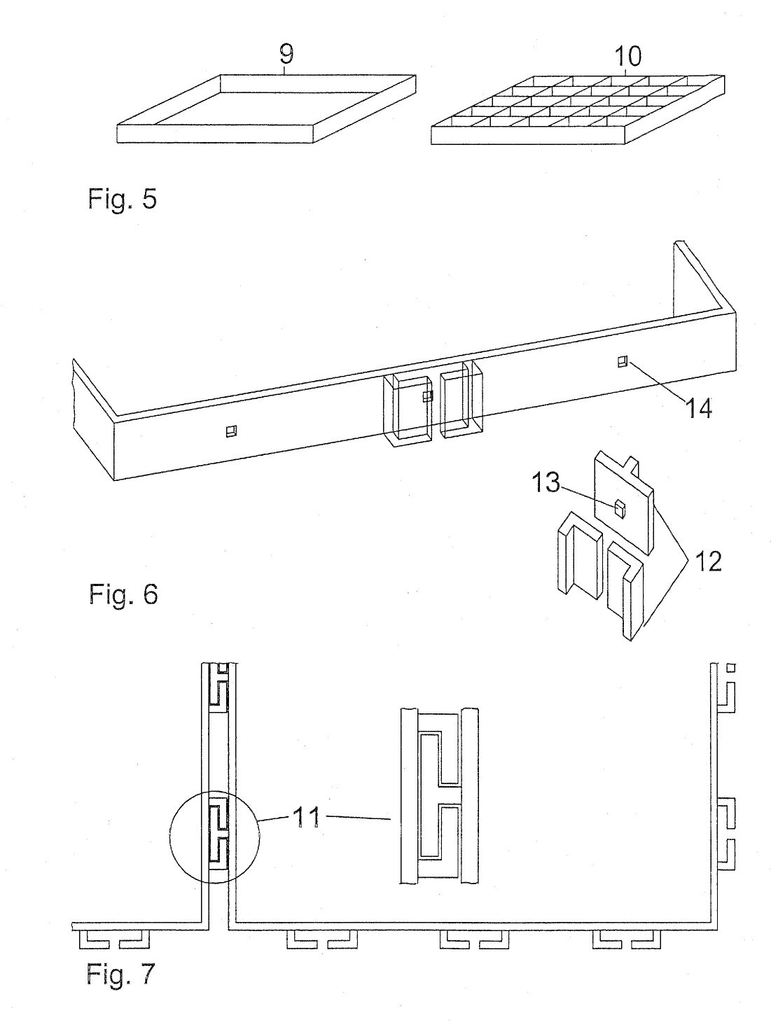

Examples of the individual elements separately are illustrated in FIG. 5 in the form of elements 9 and 10. It is also possible for attachment points to be arranged in the middle of the disk. Netting or fabric must for this purpose be extremely large in size and only a fraction of the total area, would, dependent on the direction of working, be utilized in each case. The advantage of the invention in this point comes into play in the case of narrow roofs for instance—see FIG. 1. The example shows a narrow roof with a width of merely 5 meter. Using prior art permanent free of penetrating systems as described above in part 2b.), such a roof could not be designed with attachment points. The dimensions of netting amount to 5 times 5 meter even for green roofs or a gravel covering. Furthermore the attachment points are arranged at the roof margins. In order for a person to attach himself at all he must get into the roof edge portion, where there is a danger of falling, with a size of 2 meter. There would at once be an impermissible working angle or, respectively, area.

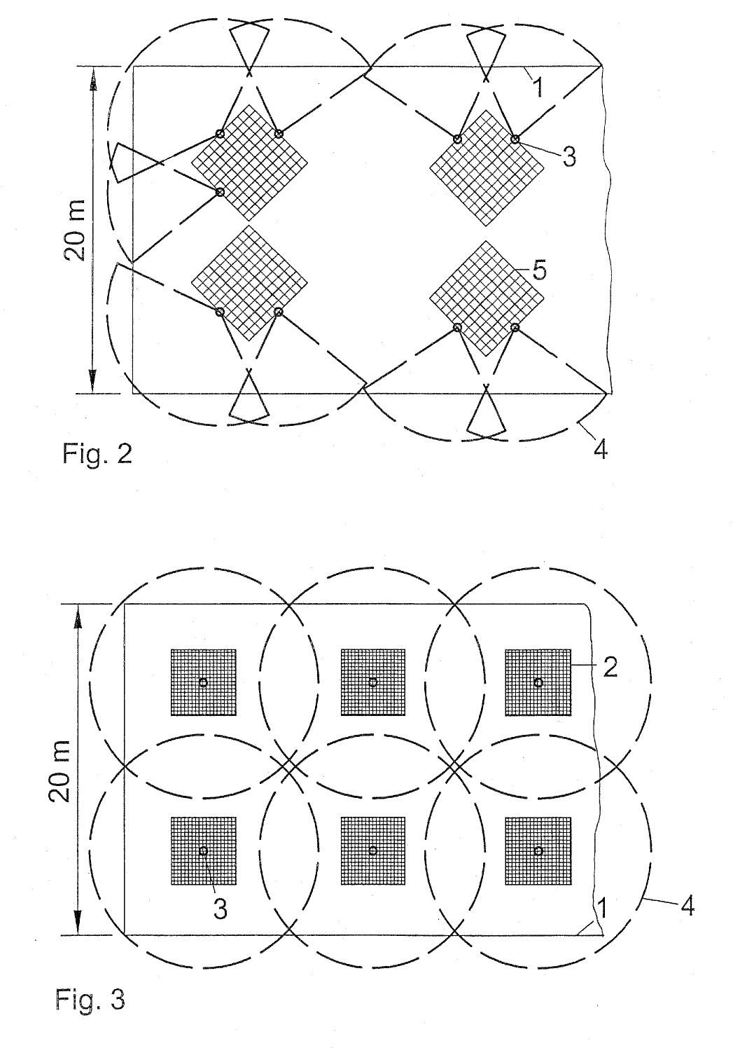

A further advantage of the invention is because generally less attachment points are required at all. The working area may in the case of attachment points, which are centrally arranged or are moved in sufficiently far, be equal to 360 degree. Accordingly a roof corner may be attended to by having only one attachment point and the risk of improperly delimited working areas will be eliminated. This is made clear by FIGS. 2 and 3. Both roof areas have exactly the same size. In the case of the standard scheme illustrated in FIG. 2 with the system, so far employed, see part 2b.) above, nine attachment points are necessary—which means that the worker must change attachment points nine times. In FIG. 3 with the system in accordance with the invention only six attachment points are necessary—even without having to have a longer length of line in the safety equipment. In accordance with FIG. 2 the worker has to pay attention to the working areas, whereas this is unnecessary in the case of FIG. 3 with the system in accordance with the invention.

Owing to individual elements, which are connected together, it is possible to adapt the area size and the area geometry per attachment point individually in a manner dependent on the possible load thereon and particular local features. Furthermore owing to there being such small units there is the advantage of improved ergonomics and simpler transport.

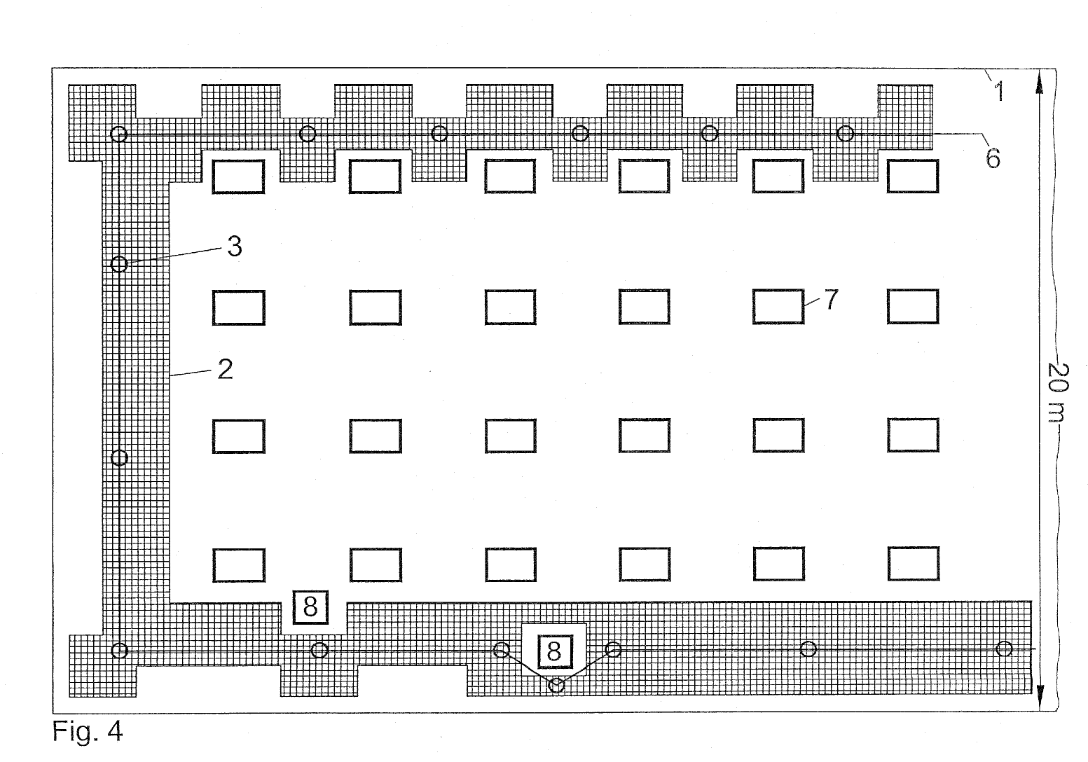

FIG. 4 shows a scheme by way of example for a surrounding safety system at the roof edge for an advantageous application of the system in accordance with the invention. The light domes have been omitted and the equivalent area size of the individual elements has been set farther toward the roof edge. Moreover other structures 7 penetrating the roof may be “dodged”. In the case of the scheme for the arrangement of the attachment points minimum distances from the edge of the disk must be observed. Otherwise the disk might be levered out of place, which will only be effective as long as it is covered by suitable material.

As described in part 2b.) above netting or fabric may not be employed without further fixed points for the provision of surrounding lines, since same require a loading tension in order in the case of a load being applied for there to be only a small shift in position. Stiffening would make this possible, but with the need for further parts. It is more practical and simpler to solve this problem however assembling small elements to make up a rigid disk or, respectively, a surrounding belt (FIG. 4). This design also involves the advantage of the possibilities of “dodging” structures penetrating the roof.

As regards the selection of the material and the accessories attention is to be paid to the fact that in the case of prolonged use on roof exposed to the weather in connection with the material serving as the loading weight corrosion and rot are to be prevented, which might otherwise reduce the safety of the attachment means in accordance with the invention. Accordingly suitable corrosion-proof and rot-proof materials are to be selected.

It is naturally necessary for the size of the disk to be constructed, the design of the individual elements, the attachment of the attachment points on the disks and the strength of the lines or belts employed and of the attachment eyes as such to be adapted to the forces occurring with an arrested fall including the necessary safety margins. The specific requirements and methods of testing are described in the German Industrial Standard DIN-EN 759, entitled “Attachment Means”. Furthermore adaptation to the most common field of use (for example green roofs and gravel-covered roofs) is to be performed taking into account the usual layer thicknesses in the case of bulk materials, for example. The individual elements to construct the disk, which is employed as a base for attachment points or, respectively, fixed points, must be of such dimensions as such and as regards connection techniques that the forces occurring may be taken up. This will apply also in the case of disks, which are not rectangular or square or disks having recesses, since in this case quite different forces relationships may be relevant.

Possible designs of an individual element are depicted in FIG. 5. In FIGS. 6 and 7 one possibility of connection is illustrated by the example. The connection of the individual elements with each other must be such that the tension forces occurring in the case of an arrested fall do not lead to detachment of the individual elements to their being thrust over each other or to a substantial deformation of the disk. As shown in FIG. 6 using a T-like plug connection a frictional connection may be produced. Owing to the additionally arranged male head and the recess or socket a detent action may be produced.

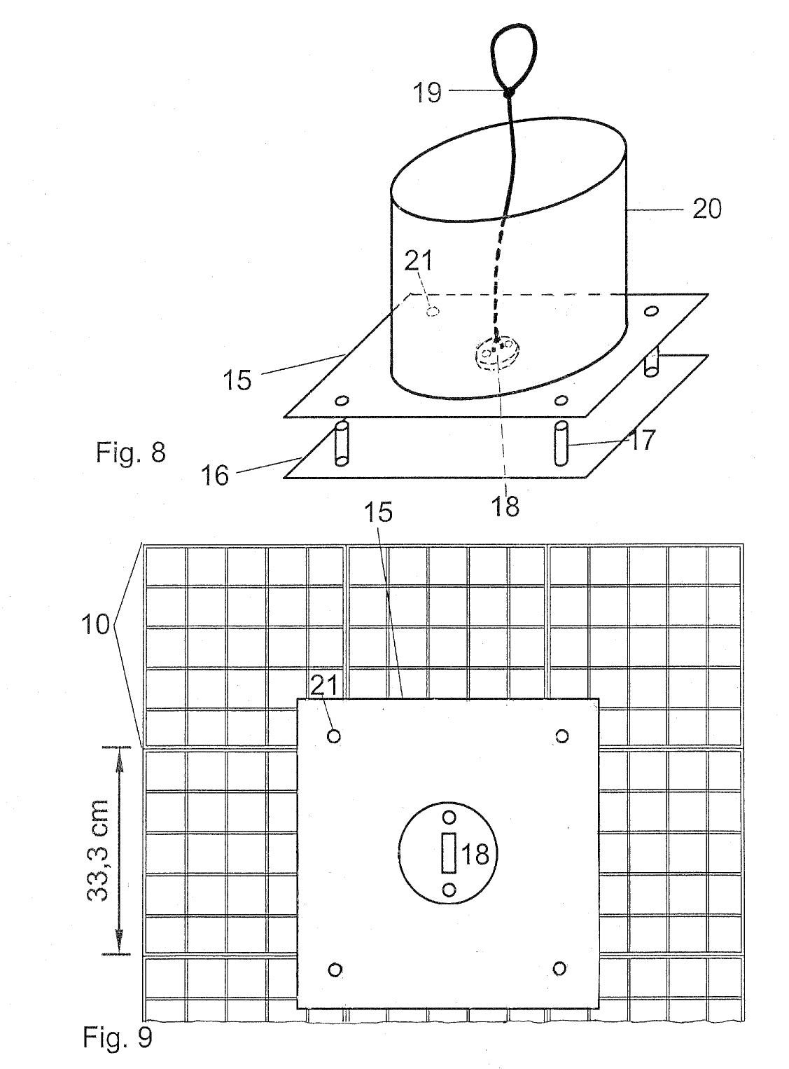

The attachment points or, respectively, also the fixed points of line securing systems (an attachment means with a horizontally moving guide) or rail systems may be integrated directly in suitably modified individual elements or may be connected by way of separate components (FIGS. 8 and 9) with the disk frictionally and if desired further stiffen the disk in addition or, respectively, render possible the transmission of forces to several individual elements of the disk (FIG. 9).

1. A System as attachment possibility for safety equipments to arrest falls produced by attachment points or, respectively, guide lines or rails secured by a weighting load, characterized in that a disk with a large area of adaptable size and form, is composed of individual elements with a small area which are designed to be connected together, said disk being arranged to be covered with a weighting load (as for example a bulk material, plates or the like) and is accordingly able to take up forces as occur in the case of arresting a fall by way of attachment points applied to it or integrated in individual elements.

2. The system as set forth in claim 1, characterized in that the disk is preferably composed of individual elements, which as such are stiffened.

3. The system as set forth in claim 1, characterized in that the individual elements may comprise a three-dimensional structure.

4. The system as set forth in claim 1, characterized in that connecting members are provided integrated in the individual members for connecting the individual members together.

5. The arrangement as set forth in claim 1, characterized in that the connection of the individual elements is performed using separate parts.

6. The arrangement as set forth in claim 1, characterized in that the connection of the individual elements is both by separate parts and also by connecting members integrated in the individual elements.

7. The arrangement as set forth in claim 1, characterized in that the individual elements for the formation of the disk comprise a size of 0.1 sq meter to 2 sq in particular 0.1 sq meter to 1.0 sq meter.

8. The arrangement as set forth in claim 1, characterized in that for individual attachment points the disk has, dependent on the respective type and height of the weighting load a size of 2 sq meter to 25 sq meter and in particular 8 sq meter to 25 sq meter.

9. The arrangement as set forth in claim 1, characterized in that individual disks may be so joined together that a larger area is available to receive the weighting load.

10. The arrangement as set forth in claim 1, characterized in that the individual elements to be connected are installed on a rot-proof protective layer.

11. The arrangement as set forth in claim 1, characterized in that the individual elements to be connected are installed on non-woven material filter fabric with an underlying drain system.

12. The arrangement as set forth in claim 1, characterized in that the disk may comprise recesses.

13. The arrangement as set forth in claim 1, characterized in that the disk has one or more attachment points or, respectively, fixed points may be applied to it in accordance with the eventual weighting load and the size of the disk.

14. The arrangement as set forth in claim 1, characterized in that attachment points or fixed points may be placed on the flat disk at practically any desired position.

15. The arrangement as set forth in claim 1, characterized in that the fixed points arranged on the disk or on several of said disks may be connected by a guide line or rails, which serve for their part as attachment devices.
